(19) United States
(12) Patent Application Publication
(10) Pub. No.: US 2009/0028058 A1
(43) Pub. Date: Jan. 29, 2009

(54) Directed Mesh Network with Link Evaluation

(75) Inventor: Thomas Freeburg, Neenah, WI (US)

Correspondence Address: BANNER & WITCOFF, LTD., TEN SOUTH WACKER DRIVE, SUITE 3000, CHICAGO, IL, 60606, US

(73) Assignee: MemoryLink Corporation, Neenah, WI (US)

(21) Appl. No.: 12/177,640

(22) Filed: Jul. 22, 2008

Related U.S. Application Data
(60) Provisional application No. 60/951,540, filed on Jul. 24, 2007.

(51) Int. Cl. G06F 11/00

(52) U.S. Cl. 370/248

(57) ABSTRACT

Techniques for communicating between a data user and a destination through a mesh network. The mesh network includes a communication node having a downstream component logically connected over a downlink to provide communications for a data user and a plurality of upstream components. The plurality of upstream components includes a first upstream component that is logically connected to a first data destination over a first uplink. The communication node also has a controlling component that selects the first upstream component based on a first comparative link quality of the first uplink, where the first downstream component is electrically coupled to the first upstream component. The controlling component determines the first comparative link quality from a plurality of link quality metrics, where a corresponding weight is associated with each link quality metric.

### FIELD OF THE INVENTION

The invention relates to interconnecting communication nodes in a mesh network.

### BACKGROUND

A wireless mesh network is a communications network often made up of radio nodes organized in a mesh topology. The coverage area of the radio nodes working as a single network is sometimes called a mesh cloud. Access to this mesh cloud is dependent on the radio nodes working in harmony with each other to create a radio network. A mesh network should be reliable by offering redundancy. When one node can no longer operate, the rest of the nodes can still communicate with each other, directly or through one or more intermediate nodes. A wireless mesh network may be seen as a type of wireless ad hoc network, where all radio nodes are static and doesn't experience direct mobility. Wireless mesh architecture is often a first step towards providing high-bandwidth network over a specific coverage area. Wireless mesh architecture's infrastructure is, in effect, a router network minus the cabling between nodes. A mesh network is typically built of peer radio devices that don't have to be cabled to a wired port like traditional WLAN access points (AP) do. Mesh architecture typically sustains signal strength by breaking long distances into a series of shorter hops. Intermediate nodes may not only boost the signal, but cooperatively make forwarding decisions based on their knowledge of the network, i.e., performs routing. Such an architecture may, with careful design, may provide high bandwidth, spectral efficiency, and economic advantage over the coverage area.

Consequently, there is a real need to facilitate effective operation of a mesh network in providing reliable communications for a data user.

### SUMMARY

The present invention supports a communication node having a downstream component logically connected over a downlink to provide communications for a data user.

With an aspect of the invention, the communication node has a plurality of upstream components, the plurality of upstream components including a first upstream component being logically connected to a first data destination over a first uplink. The communication node also has a controlling component that selects the first upstream component based on a first comparative link quality of the first uplink, where the first downstream component is electrically coupled to the first upstream component.

With another aspect of the invention, the communication node of claim 1, the controlling component determines the first comparative link quality from a plurality of link quality metrics, where a corresponding weight is associated with each link quality metric.

With another aspect of the invention, an upstream component includes an upstream radio and an upstream directional antenna.

With another aspect of the invention, a downstream component includes a downstream radio and a downstream directional antenna.

This Summary is provided to introduce a selection of concepts in a simplified form that are further described below in the Detailed Description. This Summary is not intended to identify key features or essential features of the clamed subject matter, nor is it intended to be used as an aid in determining the scope of the claimed subject matter.

### BRIEF DESCRIPTION OF DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 shows an architecture of a node in a mesh network in accordance with an embodiment of the invention.

FIG. 2 a mesh network in accordance with an embodiment of the invention.

FIG. 3 shows an evaluation matrix in accordance with an embodiment of the invention.

### DETAILED DESCRIPTION

Overview

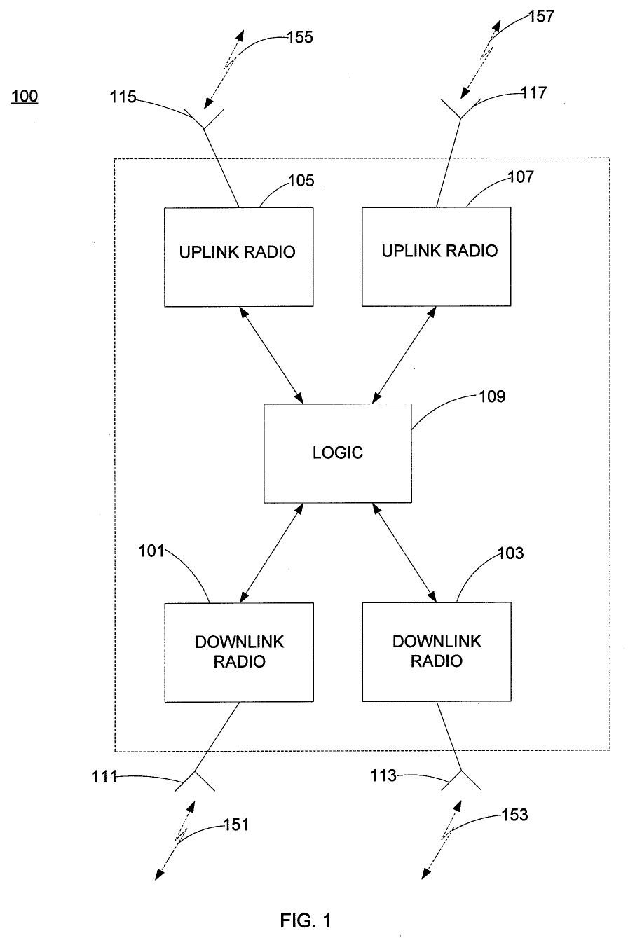

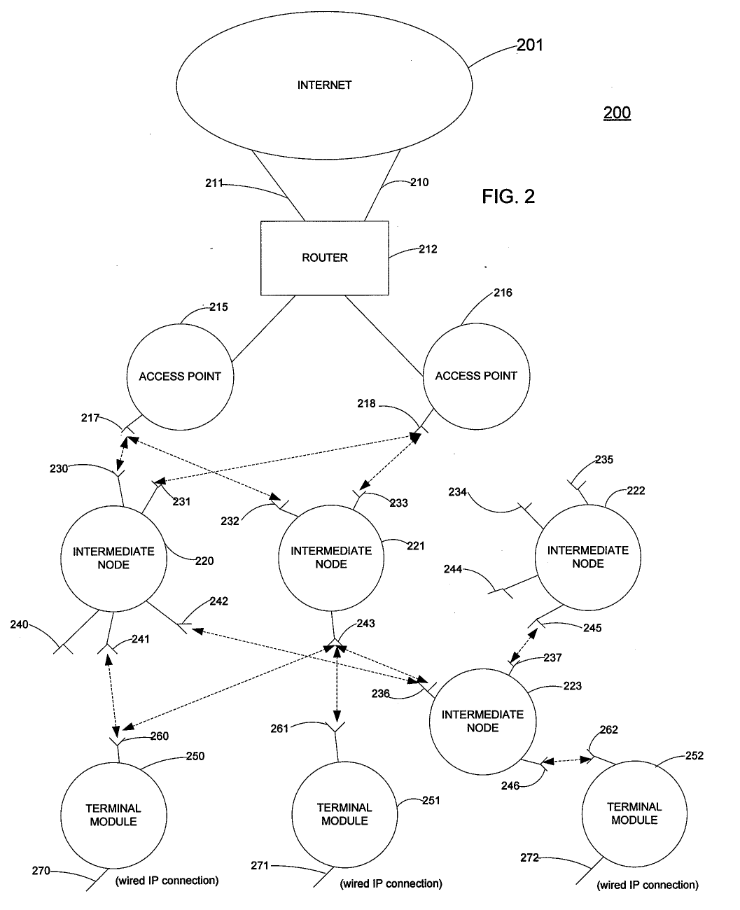

FIG. 1 shows an architecture of node 100 in a mesh network in accordance with an embodiment of the invention. A communication system comprises a wireless mesh network (e.g., mesh network 200 as shown in FIG. 2) having a plurality of communication nodes. Communication node 100 includes a logic element 109 interconnecting one or more upstream radios 105 and 107 with each upstream radio having an associated gain (e.g. directional) antennas 115 and 117. The downstream radios 101 and 103 are connected to antennas 111 and 113, respectively. Communication node 100 communicates with other communication nodes over uplinks 155 and 157 and downlinks 151 and 153.

Embodiments of the invention support directional antennas providing performance improvement while offering desirable characteristics of mesh network operation. However, embodiments of the invention may have a network topology with omnidirectional coverage patterns.

Mesh Network

FIG. 2 a mesh network in accordance with an embodiment of the invention. With this architecture, the local network is connected to global Internet by 201 through one or more links 210 and 211. Load-sharing and fallback is provided by the operation of wired router, as is understood by one skilled in the art.

Immediately below this layer are several “layer 1” access points 215 and 216, each with its own connection to router 212. Each of these is equipped with its own (typically directional) antennas 217 and 218.

Mesh network 200 include intermediate nodes 220, 221, 222, and 223, each equipped with one or more upstream antennas 230-235, and one or more downstream antennas 246. Mesh network 200 provides connection flexibility. For example, communication node 220 may connect directly with access point 215 via antenna 230, and/or with access point 216 via antenna 231. Similarly, communication nodes 221 and 222 may connect with both or either access points 215 and 216. (In the following discussion, a communication node is referred as a node.)

With embodiments of the invention, node 223 does not connect to either access points 215 and 215, but rather can reach either of node 220 or node 221 through antenna 236. Node 223 can also communicate with node 222 via antenna 237. It could also be located as to reach access point 216 through either antenna. With embodiments of the invention, a layer of links may be included or skipped.

Terminal nodes 250, 251, and 252 are each equipped with one upstream antenna, corresponding to antennas 260, 261, and 262, respectively, and are connected to wired IP connections 270, 271, and 272, respectively. Terminal nodes 250, 251, and 252 may also be equipped with two or more upstream antennas. In such a case, terminal module 250 may configure a connection to node 220 through antenna 241 and to node 221 through antenna 243. Node 251 connects only to node 221, while node 252 connects only to node 223 in the exemplary configuration shown in FIG. 2.

Operation

As illustrated in FIG. 2, each of the nodes 220-223 operate to connect traffic received on any of their downlink antennas, while terminal modules 250-252 operate to connect traffic received on wired IP connections 260-262. The logic element 109 (as shown in FIG. 1) within each node or terminal module operates so as to choose a selected connection for each of the nodes, terminal modules, or wired connection depending from it. A connection may be chosen separately. Thus, for example, node 221 may choose to connect terminal module 250 received on antenna 243 and to access point 215 through antenna 232, while connecting node 223 received on antenna 243 to access point 216 through antenna 233.

Logic element 109 may employ one or more of several methods to differentiate among the links available as will be discussed.

Link Quality Metrics

There are several ways to choose among the links available at any one node in the mesh. These include the following:
1. Signal Quality (Q): With this method, the quality of the signal is evaluated by circuitry associated with the link receiver corresponding to each available uplink. The signal quality must consist of more information than the commonly-used Receive Signal Strength Indicator (RSSI), since path impairments, e.g., multipath reception, may have a major effect that RSSI does not detect.
2. Number of hops (H): This may be considered as “logical distance”. The number of hops can often be determined from the appropriate field in the InterNet Protocol (IP) datagram header. It is often used in ordinary routers in wired systems.
3. Load Sharing (L): With this method, some packets are sent via one path, and some via the other (or others), with the proportion of packets being determined by the relative capacity of the various links available. This may be more difficult to manage from the downstream side of the link, since the router at the upstream side must be involved in the decision.
4. Ping Time (P): With this method, the logic circuit in the individual node sends regular IP “ping” requests to a known upstream address via each of the available uplinks, and measures the time for a response. This method is attractive because the ping time is responsive to many of the key elements—path quality, link speed, and link loading all affect the response time.
5. Physical Distance (D): This may be a useful measure, since the net interference possibility is proportional to the coverage area of the associated antenna pair and thus to the physical length of the link. This method can also be improved by using the length of the longest link as a weighting factor.
6. Timing Information (T): Radios may use timing information to coordinate the transmissions from the various nodes, so as to minimize interference and therefore maximize the use of the radio spectrum (extensions of this are described in another part of this application). This timing information may be extended from hop to hop in a mesh network, but may degrade according to the number of hops (links) and link quality. In the case, where more than one uplink is available, the timing from each link can be observed, where a “filtered reference” is developed from their combination (using for example multidimensional Kalman filtering). Each available link's timing may be compared to that reference to develop a link quality metric.

Combinatorial Link Evaluation

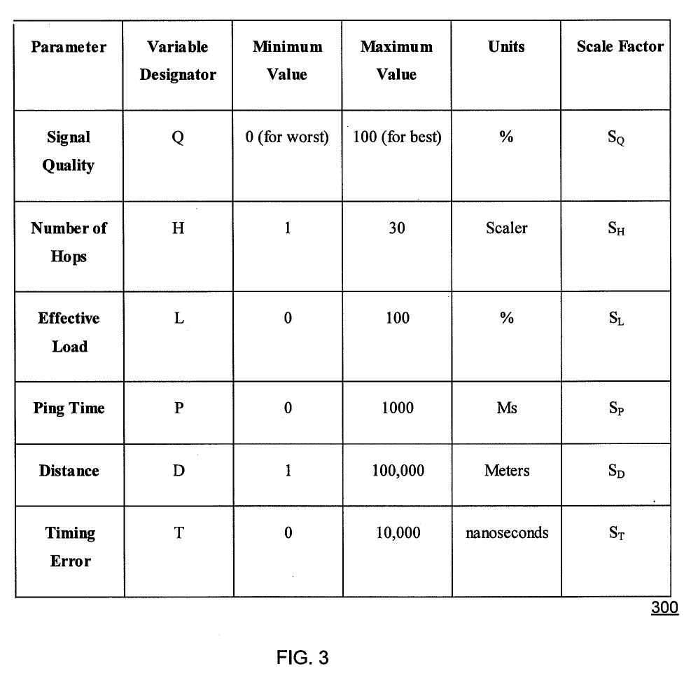

FIG. 3 shows evaluation matrix 300 in accordance with an embodiment of the invention. The selection of a link between an upstream component and data destination. With embodiments of the invention, the selection of a wireless link (e.g., link 231 as shown in FIG. 2) is based on a combination of a plurality of characteristics (e.g., the link quality metrics as discussed above). The overall link figure of merit M may be determined by:

$$M = \frac{Q}{100} {S}_{Q} + \frac{1}{H} {S}_{H} + ( 1 - {L}^{2} ) {S}_{L} + \frac{1}{P} {S}_{P} + \frac{1}{1 + \frac{4000}{D}} {S}_{D} + \frac{1}{1 + \frac{T}{100}} {S}_{T} \qquad ( EQ . 1 )$$

where the Sₓ factors are the weights corresponding to the associated parameter.

With embodiments of the invention, the actual values in EQ. 1, the scaling for each parameter, and the actual parameters selected for evaluation may be different for different mesh networks. For example, if the observed packet error rate and the variation of packet arrival time are considered significant parameters for a mesh network, the corresponding factors may be added to the evaluation matrix in FIG. 3.

Central Control

In an alternative embodiment, control of each link can be asserted from a central point, where one of two command schemes may be implemented: automatic control, or manual control. In either case, logic at the central point may keep track of one or more of the aforegoing evaluation methods, either by querying logic element 109 in each node, or by direct measurement. With the manual method, this information may be presented for the use of a human operator, most desirably in the form of a system diagram or graph with the characteristics of each link clearly displayed, for instance, by showing better links as thicker lines. The human operator would then make the appropriate decisions about routing at each of the nodes, using for example a computer mouse or keyboard to indicate the links to be used.

With the case of automatic implementation, the logic at the central control point may use the link quality information gathered as described above to choose the preferred link or links for each path, in the same manner as the automatic routing for a mapping program chooses a route for a driver to follow—by tracing a number of alternative routes, and picking the one with the best overall performance. The route so chosen may then be displayed on a computer screen, using the same sort of techniques described for presentation to a human operator.

Alternative Implementations

There of course is no reason to limit the type of system controlled by this logic to wireless system. Links may assume a wireless configuration, as shown in FIGS. 1 and 2. Moreover, links may be any data bearer or combinations thereof, such as coaxial cable, twisted pair, optical fiber, and so forth.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I claim:

1. A communication node comprising:
a first downstream component logically connected over a first downlink to provide communications for a first data user;
a plurality of upstream components, the plurality of upstream components including a first upstream component, the first upstream component being logically connected to a first data destination over a first uplink; and
a controlling component configured to select the first upstream component based on a first comparative link quality measure of the first uplink, the first downstream component being electrically coupled to the first upstream component.

2. The communication node of claim 1, the controlling component configured to determine the first comparative link quality measure, the first comparative link quality measure being determined from a plurality of link quality metrics.

3. The communication node of claim 2, the controlling component configured to select a corresponding weight for each of the plurality of link quality metrics.

4. The communication node of claim 1, further comprising:
the first downstream component logically connected over a second downlink to provide communications for a second data user;
the plurality of upstream components including a second upstream component, the second upstream component being logically connected to a second data destination over a second uplink; and
the controlling component configured to select the second upstream component based on a second comparative link quality measure of the second uplink, the first downstream component being electrically coupled to the second upstream component.

5. The communication node of claim 1, the first upstream component comprising an upstream radio and an upstream directional antenna.

6. The communication node of claim 1, the downstream component comprising a downstream radio and a downstream directional antenna.

7. The communication node of claim 1, further comprising:
a second downstream component logically connected over a second downlink to provide communications for a second data user;
the plurality of upstream components including a second upstream component, the second upstream component being logically connected to a second data destination over a second uplink; and
the controlling component configured to select the second upstream component based on a second comparative link quality measure of the second uplink, the second downstream component being electrically coupled to the second upstream component.

8. The communication node of claim 1, wherein:
a different comparative link quality measure is associated with a different upstream component; and
the controlling component configured to select the first upstream component rather than the different upstream component when the first comparative link quality measure is greater than the different comparative link quality measure.

9. A method comprising:
connecting a first downstream component over a first downlink to provide communications for a first data user;
selecting a first upstream component based on a first comparative link quality measure for a first uplink, wherein the first upstream component is connected to a first data destination over the first uplink and wherein the first upstream component is one of a plurality of upstream components; and
coupling the first downstream component with the first upstream component.

10. The method of claim 9, further comprising:
determining a different comparative link quality measure that is associated with a different upstream component; and
selecting the first upstream component rather than the different upstream component when the first comparative link quality measure is greater than the different comparative link quality measure.

11. The method of claim 9, wherein the first comparative link quality measure is a function of a signal quality metric of the first uplink.

12. The method of claim 9, wherein the first comparative link quality measure is a function of a number of hops associated with the first uplink.

13. The method of claim 9, wherein the first comparative link quality measure is a function of a load sharing metric of the first uplink.

14. The method of claim 9, wherein the first comparative link quality measure is a function of a ping time metric of the first uplink.

15. The method of claim 9, wherein the first comparative link quality measure is a function of a physical distance metric of the first uplink.

16. The method of claim 9, further comprising:
coordinating transmission with a plurality of communications nodes based on timing information; and
wherein the first comparative link quality measure is a function of a timing information metric of the first uplink.

17. A system comprising:
a plurality of downstream components connected to corresponding downlinks;
a plurality of upstream components connected to corresponding uplinks; and
a controller configured to select a route from a user to a destination spanning at least one of the plurality of downstream components and at least one of the plurality of upstream components based on an overall performance, wherein the route comprises a plurality of links and wherein each link corresponds to a corresponding comparative link quality measure.
